(19) United States
(12) Patent Application Publication
(10) Pub. No.: US 2018/0167457 A1
(43) Pub. Date: Jun. 14, 2018

(54) OPTIMIZING TRAFFIC

(71) Applicant: NOKIA SOLUTIONS AND NETWORKS OY, Espoo (FI)

(72) Inventor: Jani Olavi SODERLUND, Vantaa (FI)

(21) Appl. No.: 15/735,010

(22) PCT Filed: Jun. 19, 2015
(86) PCT No.: PCT/EP2015/063794

§ 371 Date: Dec. 8, 2017

(51) Int. Cl. H04L 29/08; H04L 12/24

(52) U.S. Cl. CPC H04L 67/1042; H04L 41/12; H04L 41/20; H04L 67/101; H04L 67/1012; H04L 67/1008

(57) ABSTRACT

A mechanism for a first apparatus in a communication network is described. The communication network comprises the first apparatus, a second apparatus and a plurality of servers. The mechanism comprises sending at least a message to the second apparatus to obtain zone information of each of said plurality of servers, receiving the requested zone information from the second apparatus, and building a topology database based on the received zone information.

### FIELD OF THE INVENTION

The present invention relates to cloud computing, network functions virtualization. Specifically, the present invention relates to methods, apparatuses, system and computer program products for optimizing traffic.

### BACKGROUND OF THE INVENTION

In cloud deployments, the emerging ETSI NVF framework as depicted in FIG. 1 is commonly used as the reference model for future mobile network elements.

Network functions virtualisation adds new capabilities to communications networks and requires a new set of management and orchestration functions to be added to the current model of operations, administration, maintenance and provisioning. In legacy networks, network function implementations are often tightly coupled with the infrastructure they run on. NFV decouples software implementations of network functions from the computation, storage, and networking resources they use. The virtualisation insulates the network functions from those resources through a virtualisation layer. The decoupling exposes a new set of entities, the virtualised network functions, and a new set of relationships between them and the NFV infrastructure. VNFs can be chained with other VNFs and/or physical network functions to realize a network service.

The network functions virtualisation management and orchestration architectural framework has the role to manage the NFVI and orchestrate the allocation of resources needed by the NSs and VNFs. Such coordination is necessary because of the decoupling of the network functions software from the NFVI.

NFVI resources under consideration are both virtualised and non-virtualised resources, supporting virtualised network functions and partially virtualised network functions.

The VNF manager is responsible for the lifecycle management of VNF instances. Each VNF instance is assumed to have an associated VNF manager. A VNF manager may be assigned the management of a single VNF instance, or the management of multiple VNF instances of the same type or of different types.

The virtualised infrastructure manager is responsible for controlling and managing the NFVI computing, storage and network resources, usually within one operator's infrastructure domain. A VIM may be specialized in handling a certain type of NFVI resource (e.g. computing-only, storage-only, networking-only), or may be capable of managing multiple types of NFVI resources (e.g. in NFVI-nodes).

The cloud management system or VIM is the entity that controls the placement of VMs, according to the rules given by an operator. The rules may also be filtered with information that is given by VNFM regarding specific needs of the particular VM (e.g. amount of cores, memory, networking, storage). Through a service API, a user may give the constraints to the VIM for a particular VM.

A VIM can place a new VM in any physical location where physical servers are under its administration. Most VIMs offer the operator different abstractions and possibilities to control the placement of the VMs. The fact that the VIM can place VMs in any location may cause problems for applications, especially for those with very tight latency requirements or large bandwidth requirements.

In FIG. 2, a typical arrangement of telecom/network equipment is illustrated. The physical server (e.g. a rackmount, which is used to describe electronic equipment and devices designed to fit industry-standard-sized computer racks and cabinets, or a blade) hosts 1 to N virtual machines (also referred to as tenants or guests). When a VM needs to communicate with some peer VM, the path for the traffic may vary significantly. In an optimal case, the traffic may be looped within one blade, while in the worst case, data packets need to pass through an interconnect module, ToR switch, possibly multiple EoR switches, then again a ToR switch and interconnect module before reaching the receiving end. This means many hops, which all may contribute to additional latency and also affect quality of service applied to the traffic flows by various levels of switches. If the operator uses all the server resources as a big pool for many different applications, it may be that a single element has VMs running over many cabinets, potentially with quite wide distribution (from network topology point of view). Moreover, when applications handling user plane traffic with large bandwidth (e.g. one VM handling 5-10 Gbps) are running in sub-optimal locations, it may consume significant portions of the overall bandwidth especially if uplinks have been oversubscribed. In the worst cases, this can lead to suffocate certain traffic paths, leading to packet losses.

Generally speaking, network elements may be logical entities under one local administration and management. These elements usually represent themselves to the outside networks with a few IP addresses, hiding the internal topology which consists of tens or hundreds of virtual machines.

As shown in FIG. 2, without any knowledge about the location of a VM, the VMs of type X have to simply use any available VM of type Z as the destination for the traffic. The “Path 1” is the worst situation, while the “Path 2” shows the optimal path. Normally VM X-1 may probably send 50% traffic to the VM Z-1 and another 50% to the VM Z-2. In an optimized scenario, the internal load balancer may direct most traffic within one cabinet (e.g. VM X-1 may use VM X-1 even up to 100% of traffic unless VM Z-1 would get overloaded).

### SUMMARY OF THE INVENTION

The present invention and its embodiments seek to address one or more of the above-described issues.

According to one aspect of the invention, there is provided a method for a first apparatus in a communication network, wherein said communication network comprising the first apparatus, a second apparatus and a plurality of servers, said method comprises sending at least a message to the second apparatus to obtain zone information of each of said plurality of servers; receiving the requested zone information from the second apparatus; and building a topology database based on the received zone information.

According to further development of the invention, the method for the first apparatus further comprises receiving a request from a first server in order to find a preferred peer server, wherein the first server and the preferred peer server are among said plurality of servers and the zone information of the preferred peer server comprises all the zones where the first server is located; updating the topology database by establishing peer relationship between the first server and its peer servers; identifying all the preferred peer servers from the peer servers based on the zone information in the topology database; and sending a list of all the preferred peer servers to the first server.

According to one embodiment of the invention, the method for the first apparatus further comprises receiving a notification from the first server, wherein said notification notifying the first apparatus to send an updated list of the preferred peer servers to the first server if any change in the topology database is relevant to the first server; updating the topology database in case of any change in the topology database; and sending an updated list of the preferred peer servers to the first server if the change in the topology database is relevant to the first server.

According to another embodiment of the invention, the method for the first apparatus further comprises setting a periodic timer; and sending the message to the second apparatus in order to obtain zone information of each of said plurality of servers when the timer expires.

According to another aspect of the invention, there is provided a method for a first server among a plurality of servers in a communication network, wherein said communication network comprising a first apparatus and said plurality of servers, said method comprises receiving a list of preferred peer servers from the first apparatus, wherein the preferred peer servers are among said plurality of servers and the zone information of any preferred peer server comprises all the zones where the first server is located; selecting a preferred peer server from the list; and requesting service from the selected preferred peer server.

According to one embodiment of the invention, the method for the first server further comprises sending a request to the first apparatus to find a preferred peer server from the plurality of servers.

According to another embodiment of the invention, the method for the first server further comprises sending a notification to the first apparatus to obtain an updated list of the preferred peer servers if any change in the topology database is relevant to the first server.

According to a third aspect of the invention, there is provided a first apparatus in a communication network, wherein said communication network comprising the first apparatus, a second apparatus and a plurality of servers, said first apparatus comprising a transceiver configured to communicate with at least the second apparatus and anyone of said plurality of servers, a memory configured to store at least computer program code, and a processor configured to cause the first apparatus to perform sending at least a message to the second apparatus to obtain zone information of each of said plurality of servers; receiving the requested zone information from the second apparatus; building a topology database based on the received zone information.

According to further modification of the invention, said processor of the first apparatus is further configured to cause the first apparatus to perform receiving a request from a first server in order to find a preferred peer server, wherein the first server and the preferred peer server are among said plurality of servers and the zone information of the preferred peer server comprises all the zones where the first server is located; updating the topology database by establishing peer relationship between the first server and its peer servers; identifying all the preferred peer servers from the peer servers based on the zone information in the topology database; and sending a list of all the preferred peer servers to the first server.

According to one embodiment of the invention, said processor of the first apparatus is further configured to cause the first apparatus to perform receiving a notification from the first server, wherein said notification notifying the first apparatus to send an updated list of the preferred peer servers to the first server if any change in the topology database is relevant to the first server; updating the topology database in case of any change in the topology database; and sending an updated list of the preferred peer servers to the first server if the change in the topology database is relevant to the first server.

According to another embodiment of the invention, said processor of the first apparatus is further configured to cause the first apparatus to perform setting a periodic timer; and sending the message to the second apparatus in order to obtain zone information of each of said plurality of servers when the timer expires.

According to a fourth aspect of the invention, there is provided a first server among a plurality of servers in a communication network, wherein said communication network comprising a first apparatus and said plurality of servers, said first server comprising a transceiver configured to communicate with at least the first apparatus, a memory configured to store at least computer program code, and a processor configured to cause the first server to perform receiving a list of preferred peer servers from the first apparatus, wherein the preferred peer servers are among said plurality of servers and the zone information of any preferred peer server comprises all the zones where the first server is located; selecting a preferred peer server from the list; and requesting service from the selected preferred peer server.

According to one embodiment of the invention, said processor of the first server is further configured to cause the first server to perform sending a request to the first apparatus to find a preferred peer server from the plurality of servers.

According to another embodiment of the invention, said processor of the first server is further configured to cause the first server to perform sending a notification to the first apparatus to obtain an updated list of the preferred peer servers if any change in the topology database is relevant to the first server.

According to a fifth aspect of the invention, there are provided computer program products comprising computer-executable computer program code which, when the computer program code is executed on a computer, are configured to cause the computer to carry out the above-mentioned method for the first apparatus and method for the first server.

According to further modification of the invention, said computer program products comprises a computer-readable medium on which the computer-executable computer program code is stored, and/or wherein the program is directly loadable into an internal memory of the processor.

According to a sixth aspect of the invention, there is provided a first apparatus in a communication network, wherein said communication network comprising the first apparatus, a second apparatus and a plurality of servers, said first apparatus comprising a transceiving means for communicating with at least the second apparatus and anyone of said plurality of servers, a memory for storing at least computer program code, and a processing means for causing the first apparatus to perform sending at least a message to the second apparatus to obtain zone information of each of said plurality of servers; receiving the requested zone information from the second apparatus; building a topology database based on the received zone information.

According to a seventh aspect of the invention, there is provided a first server among a plurality of servers in a communication network, wherein said communication network comprising a first apparatus and said plurality of servers, said first server comprising a transceiving means for communicating with at least the first apparatus, a memory for storing at least computer program code, and a processing means for causing the first server to perform receiving a list of preferred peer servers from the first apparatus, wherein the preferred peer servers are among said plurality of servers and the zone information of a preferred peer server comprises all the zones where the first server is located; selecting a preferred peer server from the list; and requesting service from the selected preferred peer server.

According to further modification of the invention, the above-mentioned zone may be formed based on anyone or any combination of the following characteristics of the plurality of servers:
physical location,
bandwidth,
QoS guarantees,
HW computing host capabilities,
SW computing host capabilities.

### BRIEF DESCRIPTION OF THE DRAWINGS

Exemplary embodiments of the invention are described below, by way of example only, with reference to the following numbered drawings.

FIG. 1 shows ETSI NVF architectural framework.

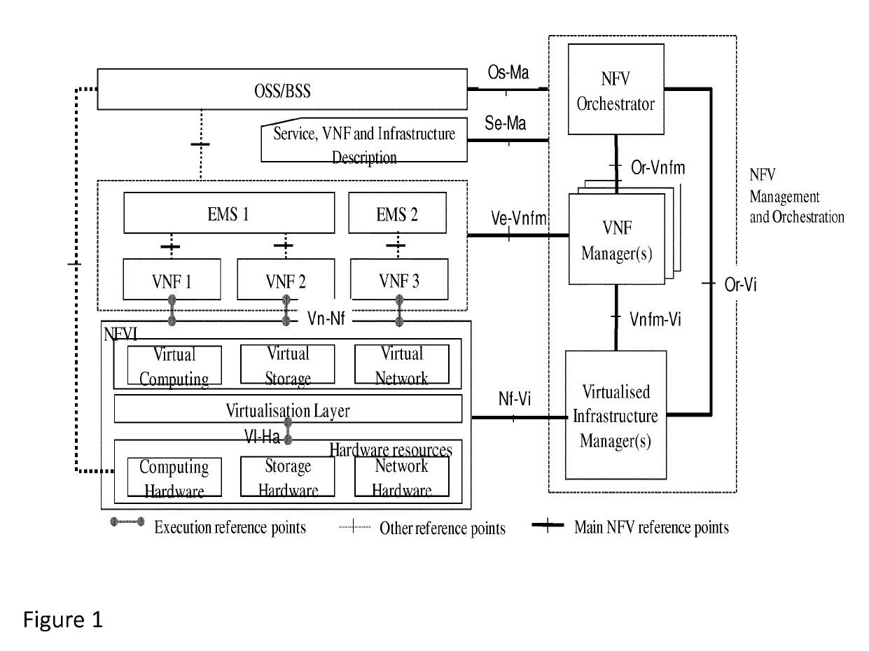

FIG. 2 illustrates an example of data traffic distribution.

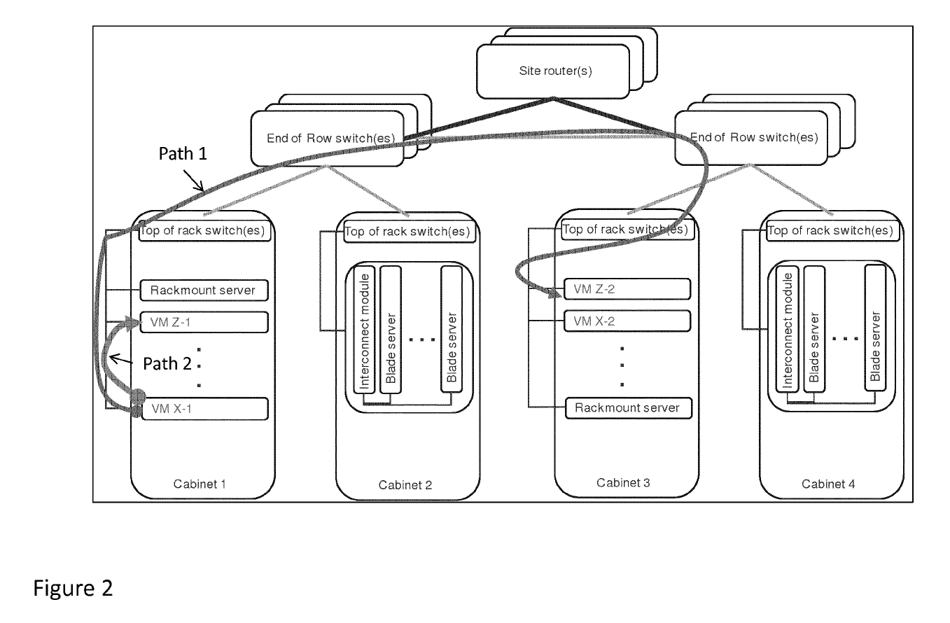

FIG. 3 depicts server aggregates according to certain embodiment of the invention.

FIG. 4 depicts VM aggregates according to certain embodiment of the invention.

FIG. 5 gives one possible arrangement of the invention.

FIG. 6 illustrates one example during VNF deployment situation according to certain embodiment of the invention.

FIG. 7 illustrates another example during VNF runtime situation according to certain embodiment of the invention.

FIG. 8 illustrates a further example when zone configuration is updated during VNF runtime situation according to certain embodiment of the invention.

FIG. 9 gives one possible implementation of the invention.

FIG. 10 shows a method according to certain embodiment of the invention.

FIG. 11 shows another method according to certain embodiment of the invention.

FIG. 12 shows two apparatus according to certain embodiment of the invention.

### DESCRIPTION OF THE EMBODIMENTS OF THE INVENTION

According to one aspect of the invention, information about the locations of possible peer nodes or service providing entity to a network element may be obtained. The network element may use this information as a hint when selecting its peer nodes or requesting services in order to find an optimal traffic path. As the result, significant amount of traffic passing through the upper layers of a data centre network topology may be reduced.

According to another aspect of the invention, an operator may define certain zones which, for example, based on a particular physical location or some other characteristic of a VM/server, depending on its needs and purpose. A zone may be a group of VMs/servers formed according to certain criteria. As a non-limiting example of the invention, the criteria may be any one or any combinations of the following parameters:
physical location: for example, IP address of an entity, cabinet or/and rack number, etc. Basically, any parameter suitable for physically locating a VM/server may be used. Entities such as VMs/servers may be grouped in a zone if they have an optimal connection towards certain services, or they are located relatively closer to each other, for instance, within the same cabinet/rack or within a range of IP address, etc.
bandwidth: the hardware in which a network element runs, might be heterogeneous, for example, some supporting 10G/40G/100G interfaces respectively or a mixture of those. Even single switch/router may support multiple links with different bandwidth. Some connections between the servers/VMs and the switching fabric might have different speeds than others. This gains importance especially if computing hosts are physically distributed across a large data center, or even across physically separate data centers. Servers/VMs supporting certain bandwidth or multiple bandwidths may form a zone, for instance.
QoS guarantees: communication may be preferably carried out over networking peers configured for certain QoS treatment and capabilities. As an exemplary example, servers/VMs guaranteeing certain QoS may be grouped into a zone.
computing host (software/hardware) capabilities: data traffic may be preferably directed to certain servers/VMs as they may have more processing power. For instance, during system upgrades, traffics are intentionally drained from servers which are going be upgraded, and redirected to other nodes. If some racks or chassis are to be upgraded at one time, it would be necessary to move all the services from that affected location/zone(s) to some other location/zone(s). As another exemplary example, some hardware may have specific HW acceleration capabilities. Some servers may have certain software specifically meant for certain service. These servers may be preferred to be utilized to the maximum extent. Hosts with certain software/hardware capabilities may form a zone. An operator may also group a few hosts/VMs to a zone in order to direct traffics for various purposes, such as system upgrade.

A VIM may be aware of which zone a VM/server runs in as the zones are configured by an operator, however, the real physical location of a VM/server needs not to be exposed to the VNFM. Upon obtaining the zone information of each VM/server, the VNFM may build a topology database for each VM/server and enable a VNF to obtain a list of VM/server located within the same zone or zones. The list may be used by a VM/server to decide which peer it intends to connect to.

As a non-limiting exemplary example, the topology database may look like Table 1. VM instance and its type may be based on VNF templates, which are initially configured by an operator. The first 3 columns (VM type, VM instance and Zone) may be built in VNFM based on the zone information obtained from the VIM. When receiving a request from VNF (e.g. VM X1) asking for a peer VM, for instance, VM of type Z, in order to get certain service. The VNFM may know that VM X1 is interested in the VM of type Z. Thus, the column “Interested VMs” may also be filled in based on the communication between the VNFM and the VNF (and its VMs). It indicates the peer relationship between a VM/server and its peer VM/server. In this particular example, the VM X1 and X2 may expect service from the VM of type Z. So the peer relationship is established between the VMX1/X2 and the VM of type Z as shown in Table 1.

TABLE 1
Topology Database

| VM type | VM instance | Zone | Interested VMs |
|---|---|---|---|
| Z | Z1 | 1 | X1, X2 |
| Z | Z2 | 1 | X1, X2 |
| Z | Z3 | 2 | X1, X2 |
| X | X1 | 1 | — |
| X | X2 | 2 | — |

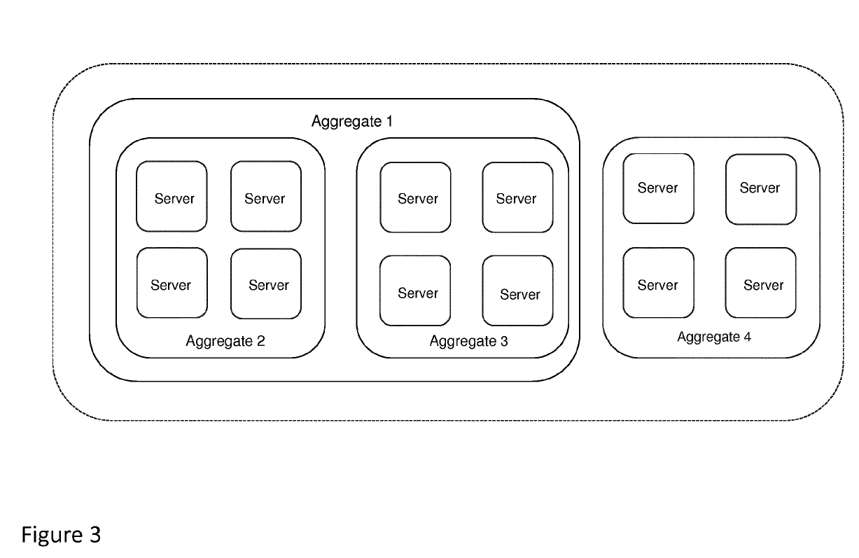

A zone may also be called as “host aggregate” or simply “aggregate” under certain circumstance, which may define particular characteristics of a group of servers/VMs belonging to it, and they may overlap. As shown in FIG. 3, a zone may be formed in many different ways according to certain embodiment of the invention.

Aggregate 1 may comprise servers of which their resources or/and capacities match the needs of a particular equipment. An operator may define additional aggregates to describe the relative locations of the servers, e.g. all hosts being under one particular switch are grouped in Aggregate 2. Similarly, any other rules/constraints/criteria may be used when forming Aggregate 3. Certain element, e.g. a server/VM, may be limited to run only within certain zone, which may also be a criterion when forming a zone according to certain embodiment of the invention.

When the VNFM starts to deploy a new VM/server, it may tell the VIM the expected resource and constraints (i.e. certain characteristics of the compute hosts that are needed, e.g. for SR-IOV support or huge page memory allocation support) of the VM. These information may be used by the VIM to allocate resources in a suitable physical server.

As the VIM may not be aware of the purpose of each VM, it cannot take the location aggregate (in the example, aggregates 2 and 3) into account at the same time when creating a VM, but makes the decision only based on the resource requirements and constraints.

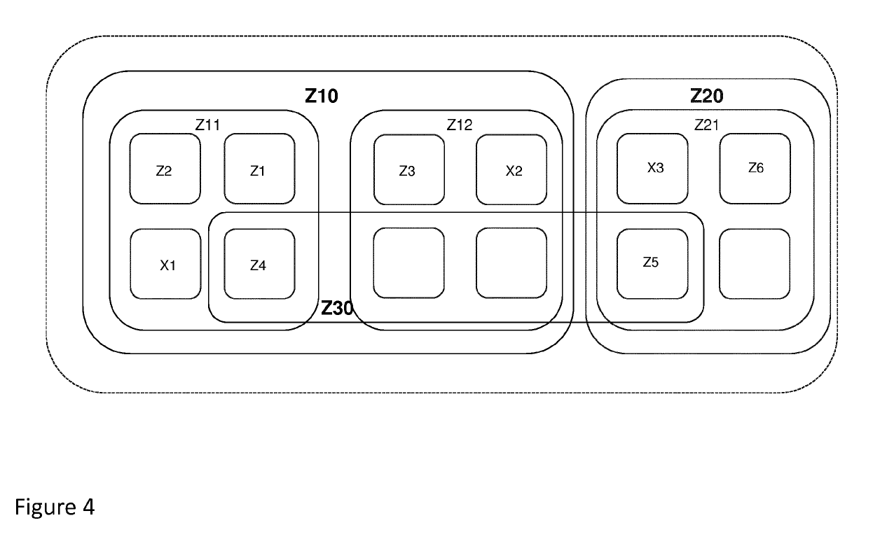

FIG. 4 provides a further example of a possible zone configuration. For the purpose of simplicity, only two types of VMs are shown in the example, type X and Z. A VM may be located in multiple zones, as depicted in FIG. 4. For instance, VM Z2 is located in zones Z11 and Z10. The topology database of FIG. 4 may look like Table 2.

TABLE 2
Topology Database of FIG. 4

| VM type | VM instance | Zone | Interested VMs |
|---|---|---|---|
| Z | Z1 | 10, 11 | X1, X2 |
| Z | Z2 | 10, 11 | X1, X2 |
| Z | Z3 | 10, 12 | X1, X2 |
| Z | Z4 | 10, 11, 30 | X1, X2 |
| Z | Z5 | 20, 21, 30 | X1, X2 |
| Z | Z6 | 20, 21 | X1, X2 |
| X | X1 | 10, 11 | — |
| X | X2 | 10, 12 | — |
| X | X3 | 20, 21 | — |

As previously stated, the first 3 columns (VM type, VM instance and Zone) of Table 2 may be built by the VNFM upon obtaining the zone information of each VM from the VIM. After receiving a request from VNF (e.g. VM X1) asking for a peer VM, for instance, a VM of type Z, the VNFM may know that VM X1 is interested in the VM of type Z. So the peer relationship between VM X1 and the VM of type Z may be established. Likewise, if the VNFM receives another request from VM X2 asking for a peer VM of type Z, it may also add X2 to the topology database as shown in Table 2 so as to establish the peer relationship between VM X2 and the VM of type Z.

Then the VNFM may find out that VM X1 is located in zone Z10 and Z11 according to the topology database. Although all the VMs of type Z are considered as peers for VM X1, the zone information of a preferred peer should comprise all the zones where VM X1 is located. In this example, VM Z1, Z2 and Z4 may be considered as the preferred peers for VM X1 as the zone information of each of them comprises the zones Z10 and Z11, where VM X1 is located. However, the zone information of a preferred peer may also comprise other zones. For example, in addition to Z10 and Z11, VM Z4 is also located in zone Z30 according to FIG. 4. VM Z4 is still qualified as a preferred peer for VM X1 despite of the fact that the zone information of VM X1 does not include Z30.

Likewise, VM Z3 may be considered a preferred peer for VM X2 because the zone information of VM Z3 comprises all the zones of VM X2, i.e. Z10 and Z12.

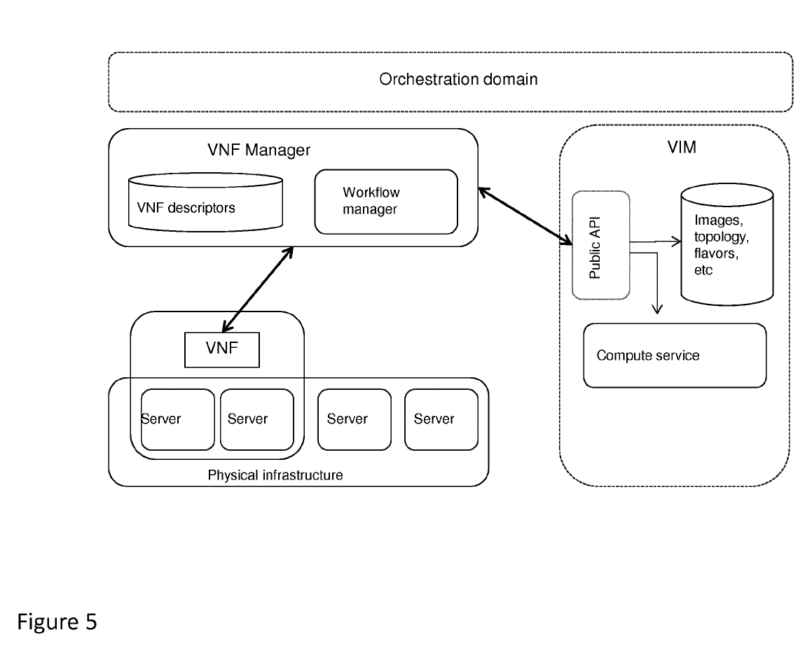

FIG. 5 shows a possible arrangement of the invention. VIM may be extended to offer a public API for a VNFM to query zone related information of any server/VM.

As servers may be added to or removed from VIM control during normal operation, and the VIM may add/remove/move VMs in these servers, the VNFM has to be updated with the latest information regarding the changes of zones and zone configuration. A background query task based on, e.g. a periodic timer in the VNFM for polling for changes, maybe added to in order to refresh information in the topology database. Alternatively, a subscription-notification mechanism may be used in this interface.

The VNFM is aware of the types of VMs that it controls, and may build a topology database for each VM and their related aggregates/zones as shown in Table 1 or Table 2 based on the obtained zone information from the VIM. According to another exemplary example, the zone may only include the possible peers sharing the same location aggregate, which would be operator specific and agreed on during the system initial deployment both in the VNFM and the VIM. The VNFM itself does not need any real intelligence relating to the roles of VMs or their aggregates as this can be done in the application specific templates, add-ons and/or plug-ins.

Any VM/server may query its peer nodes to the VNFM. As one embodiment of the invention, VM/server may give more loads to VMs/servers in its proximity, taking into account the load situation so that the selected VMs/servers will not be overloaded.

Through the interface between VNFM and VNF(VMs), the VNFM may send VM identity information to the VM, and receive a response comprising the VM identity and all the zone information relating to the VM. The VNFM may indicate (either in the VM instantiation or afterwards using a different message) that it wants to receive such information as soon as possible if zone information of certain VMs has changed (and providing a list of those). The zone information may be freely modified by the operator during runtime, so the initial information might change. Another option may be that VNFM periodically queries (refreshes) the information from VIM.

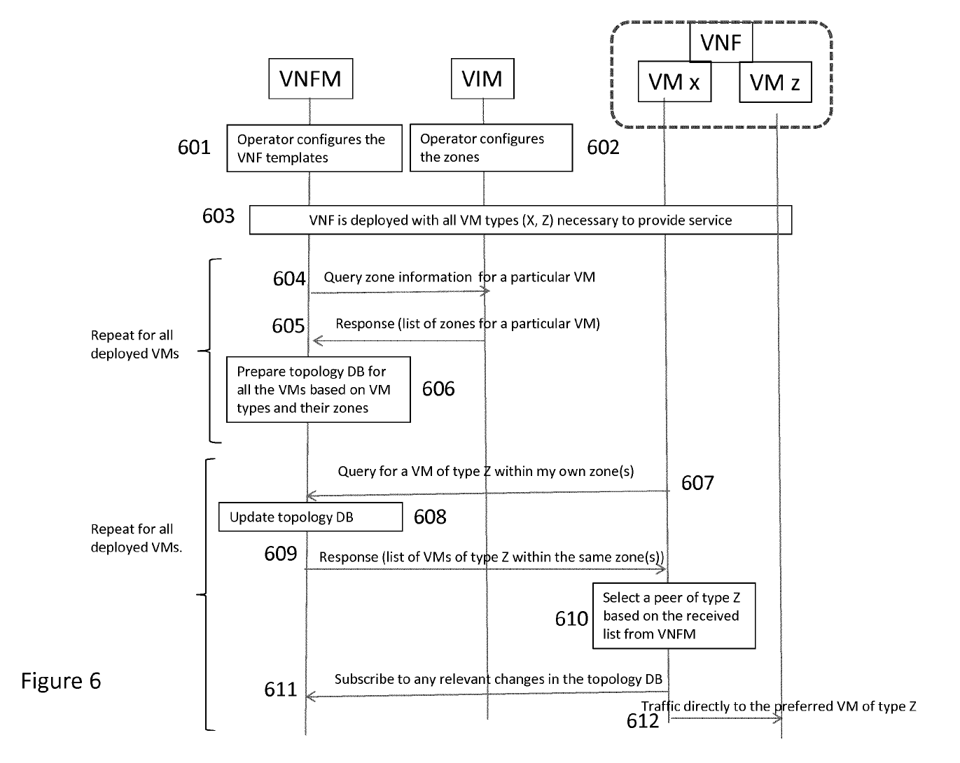

According to a further embodiment of the invention, a new VNF is deployed as depicted in FIG. 6, with 2 types of VMs (X, Z) and some instances of both VM types. When a new VM is created or deployed, it may be called as an instance of that VM type. For the sake of clarity, only two types of VM and one instance of each VM type are shown in the figure. In real implementation, there may be multiple VMs of many different types in a cabinet. As an exemplary example, a VM of type X may request services provided by a VM of type Z.

Initially, an operator may configure VNF templates, which describe the VM types and/or their respective resource needs, in VNFM and zone information in VIM respectively as indicated in 601 and 602. In this example, the zone information may be formed based on physical location of VMs.

Then the VNF comprising X and Z types of VMs may be deployed to the system in 603. The VNFM may query zone information of each VM, e.g. which zone(s) a VM belongs to, from the VIM in 604. Based on the response 605 from the VIM, the VNFM may build up a database comprising topology information for each VM in 606. The topology database may look like something similar to Table 1 or 2.

Then, a VM of type X may send a message to VNFM to search for a preferred VM of type Z in 607. Generally speaking, zone information, including that of its own, is not exposed to a VM. The zone information remains in the management domain (VNFM), which makes and maintains the topology database. The mechanism is totally non-intrusive, i.e. it is transparent to a VM. The VNFM may update the topology database in 608 to establish the peer relationship between the VM x and the VM of type Z as it knows that the VM x expects some service from the VM of type Z. Then the VNFM may identify all the preferred VM of type Z based on the zone information in the topology database and send a list of the preferred peers to the VM x in 609.

Upon receiving the list, the VM x may select a peer VM from the list so as to send most of the traffic there as shown in 610 & 612. As stated previously, a zone may be formed based on other parameters in addition to locations of VMs.

A VM within the VNF, such as VM x, may also be able to subscribe to any relevant changes in the topology database. The VM x may send a request 611 to the VNFM so that it will be informed whenever there is any relevant change of topology information, for instance a peer is removed, a new VM is added to the network, zones are re-configured, etc. Alternatively, the VM may periodically poll the VNFM in order to find out if there are any relevant changes in the topology database. Timing of the polling is not critical as the VNF itself may be aware of if a node, which is part of it, goes down or not, and switch to some other peer based on the topology information. As always, optimization is secondary to recovery.

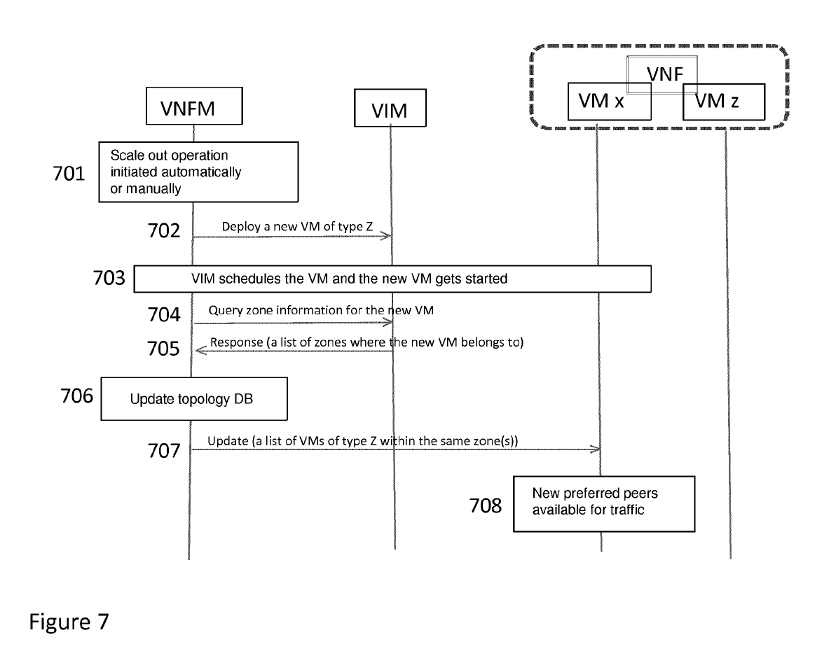

According to another embodiment of the invention, a new VM is added to VNF during runtime operation as dynamic scaling is an essential part of the cloud storyline as shown in FIG. 7. Similar to FIG. 6, VM of only two types (X and Z) are shown in the figure for the sake of simplicity. In fact, there may be multiple VMs of many different types deployed in a system.

Instead of a VM querying a preferred peer, the VNFM may push such information to the VM (e.g. VM x which may have previously requested VMs of type Z for service). This subscription can be implicit (based on previous query), or explicit (a subscription parameter in the interface), or the subscription interface might even be optional as VMs may also poll updates in VNFM periodically.

The VNFM may send a request 702 to the VIM that it may deploy a new VM of type Z. The VIM may schedule the VM by placing it to a physical server and the new VM may get started in 703. The zone information of the new VM may be configured by an operator based on its physical location or other characteristics (not shown in the figure) in the VIM. Then the VNFM may request zone information of the new VM from the VIM as indicated in 704. Upon receiving the response 705 from the VIM, the VNFM may update the topology database for the new VM in 706.

Based on the previously established peer relationship, e.g. the peer relationship between VM x and VM of type Z, the VNFM knows that VM x may be also interested in the newly deployed VM because it is a VM of type Z. In 707, the VNFM may send VM x an updated list of VMs of type Z provided that the newly deployed VM of type Z is a preferred peer VM of VM x according to the updated topology database.

As stated previously, physical location may be one of the possible parameters when forming a zone. Other options of building a zone are also possible. So the list of the preferred peers may be some VMs having more computing capacity, and/or offering better service, and/or may guaranteeing certain QoS requirement, and/or ensuring certain bandwidth. In the case of multiple VMs of type X, the VNFM may send an updated list of the preferred peers to each of them depending how the zone is configured.

After receiving the list, the VM x may take the newly deployed VM of type Z into account when it needs to contact its peer as shown in 708.

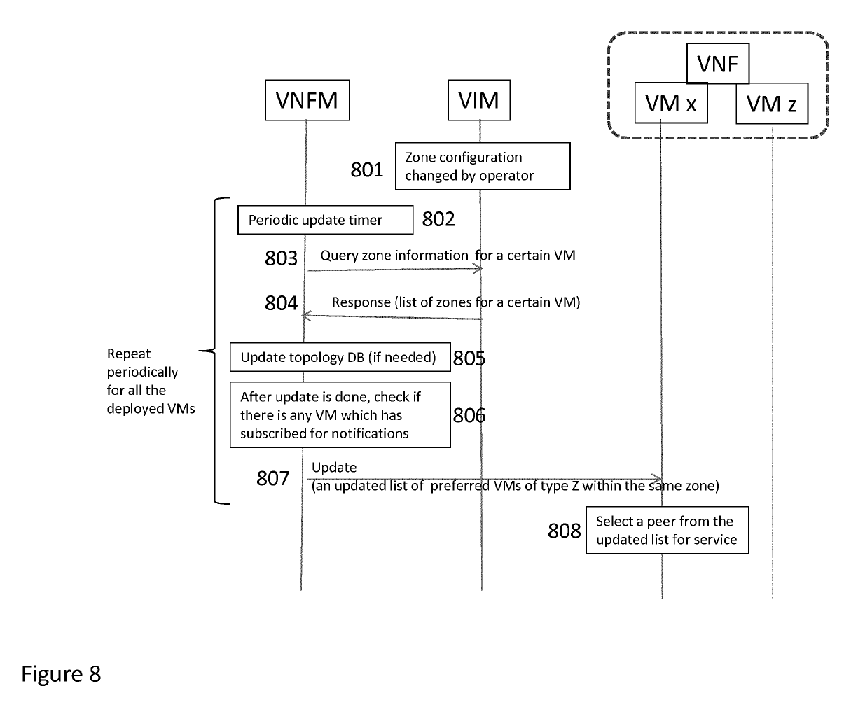

As zone information is configured by an operator, it may be re-configured during runtime as shown in FIG. 8 according to certain embodiment of the invention. A timer 802 may be set in a VNFM in order to periodically poll the VIM for obtaining the zone information as shown in 803 and 804 respectively. The topology database may also be updated accordingly as indicated in 805. In case any VM has subscribed to notification of change in topology database relevant to them, the VNFM may send an updated list of preferred peer servers based on the updated topology database in 807. The VM may then select certain peer server from the list when it needs corresponding service in 808.

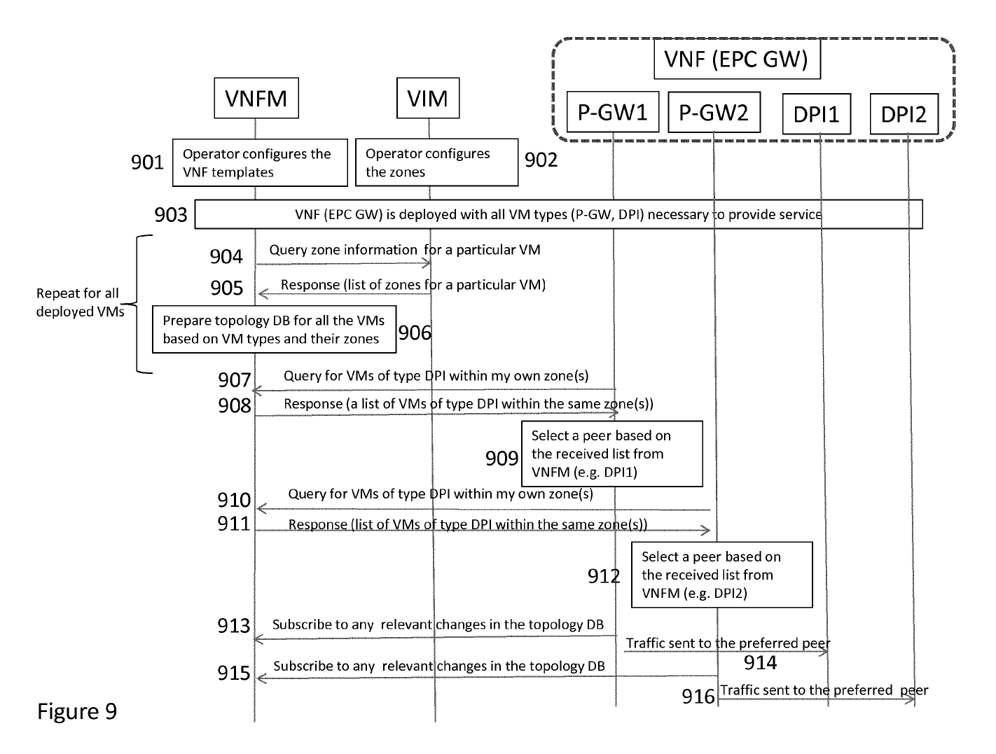

As a practical non-limiting example as illustrated in FIG. 9, where the invention may be implemented in real deployments, EPC GWs (e.g. P-GW1, P-GW2) may form a service chain, such as VNF. When a packet enters a gateway node (e.g. P-GW1 or P-GW2) and PCC rules may mandate DPI processing, the packet is sent to another VM (e.g. DPI1 or DPI2) dedicated for DPI service. After this, the packet is returned to the gateway node and relayed towards the destination. Being part of the same network element, the P-GW VMs know the addresses of all DPI VMs, but do not know which one of all the possible DPI VMs would be optimal for the traffic flows.

As illustrated in FIG. 9, after the initial configuration and deployment in 901-903, topology database of all the VMs may be build in the VNFM after repeating the steps 904-906. The P-GW1 may query the VNFM in order to find a preferred DPI peer in 907. The P-GW1 may receive a list of the preferred DPI VMs in 908. The P-GW2 may do the same as illustrated in 910-911. Based on the obtained lists, P-GW1 and P-GW2 may select its optimal DPI VM in 909 and 912 respectively.

This invention is basically applicable to any product which needs to communicate with other counterpart although only servers and VMs are used as examples throughout the application. It would be obvious for a skilled person in the art to understand that they are not meant to limit the scope of the invention. Generally speaking, a physical server may have several VMs or virtual servers running inside. Another practical use case may be to optimize traffic in a particular service chaining solution, where the value-add services would be added in-line to the packet processing chain basically inside one network element.

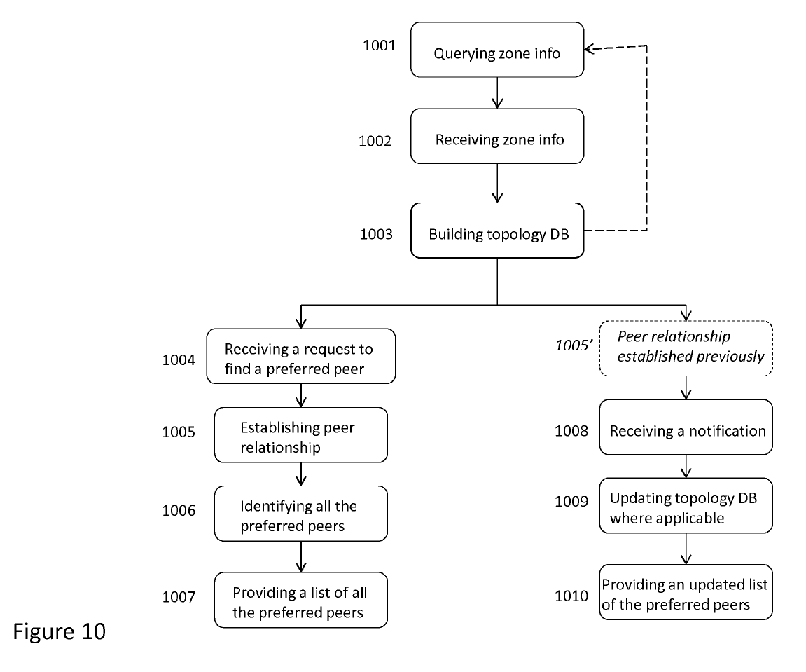

FIG. 10 illustrates a method according to certain embodiment of the invention. The method may be performed by a network element such as a VNFM or any other suitable network element. At 1001, the VNFM may send a message to another network element, e.g. VIM, in order to query zone information of a VM. Upon receiving the query message, the VIM may provide the requested information, which may be received by the VNFM at 1002. Based on the received information, VNFM may build up a topology database for the VM at 1003. Step 1001-1003 may be repeated until the zone information of every VM within a network has been collected by the VNFM. This kind of situation often happens in VNF deployment phase.

Then, at 1004, the VNFM may receive a message from a VM in search of a preferred peer VM. Based on the message, the VNFM may establish the peer relationship in the topology database between the VM and all its peers in 1005, for example, VM x and all the VMs of type Z as illustrated in FIG. 6. Then the VNFM may identify all the preferred peer VMs based on the zone information in the topology database in 1006. The VNFM may provide a list of all the preferred peer VMs to the requesting VM in 1007.

When the network is at runtime, a new VM may be added to the network, which may also trigger the steps 1001-1003 as depicted in FIG. 7. At some point, the VNFM may receive a notification 1008 from certain VM which may wish to be notified in case there is any change in the topology database relevant to the VM, e.g. a new peer VM has joined the network. Based on the previously established peer relationship 1005′, VNFM knows that the VM may be interested in receiving service from the newly deployed VM, for example, a VM x needs service from VM of type Z as illustrated in FIG. 7. The topology database may be updated in 1009 due to the deployment of the new VM. The VNFM may provide an updated list of the preferred peer VMs to the VM in 1010 if the newly deployed VM is qualified as its preferred peer VM (e.g. VM x in FIG. 7).

The same mechanism is applicable to the situation when a VM is removed from the network, either temporally or permanently. The topology database may be updated during the procedure 1101-1003 due to the removal of the VM. Where applicable, the peer relationship may be updated accordingly in 1009. The VNFM may provide an updated list of the preferred peers to the relevant VM in 1010.

The same mechanism is also applicable to the situation when zone information is re-configured by an operator. The topology database may be updated accordingly by repeating the procedure 1001-1003. Then peer relationship may be established when receiving a request from a VM as indicated in 1005. Alternatively, the previously established peer relationships 1005′ may be used. A list of preferred peers may be identified in 1006 or updated in 1009.

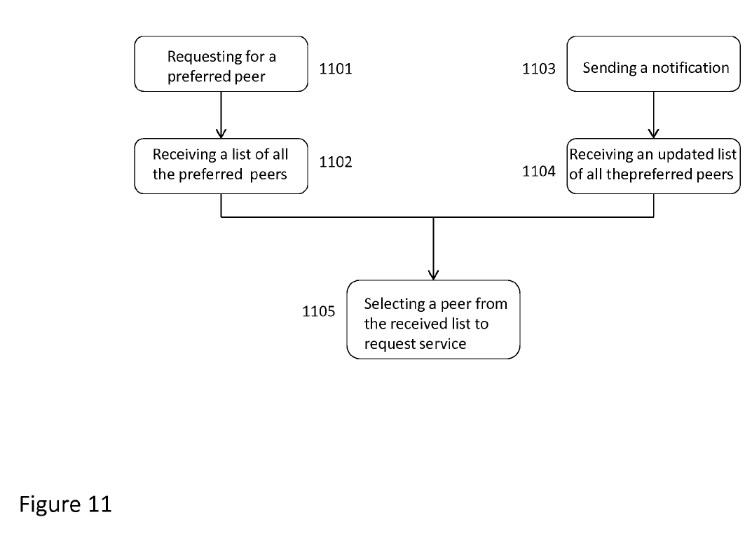

FIG. 11 illustrates another method according to certain embodiment of the invention. The method may be performed by a network element such as a VM/server or any other suitable network element. At 1101, the VM may send a message to another network element, for instance a VNFM, for the purpose of finding a preferred peer VM/server. The VM/server may receive a list the preferred peer from VNFM at 1102. The VM/server may then select a preferred peer from the list at 1105 and request the service from it. The selection logic depends on applications, for example, the VM may have additional info of the current load situation of each of the preferred peers in the received list. If without any additional information, it may select anyone, e.g. doing round robin selection among all the peers in the list. Generally speaking, the above scenario (1101->1102->1105) typically happens during the deployment phase of VNF.

During runtime, a VM/server which may wish to be notified in case there is any change in the topology database relevant to the VM/server. The change may be caused by various reasons, e.g. a new peer has joined the network, a VM is removed from network, a VM fails or zones have been re-configured, etc. A VM/server may at any point send a notification 1103 to the VNFM in order to be notified if such change is relevant to the VM/server. The VM/server may receive an updated list of the preferred peers from the VNFM in 1104. The VM/server may select a preferred peer from the updated list in 1105 when it needs relevant service. Generally speaking, the scenario (1103->1104->1105) typically happens during the runtime.

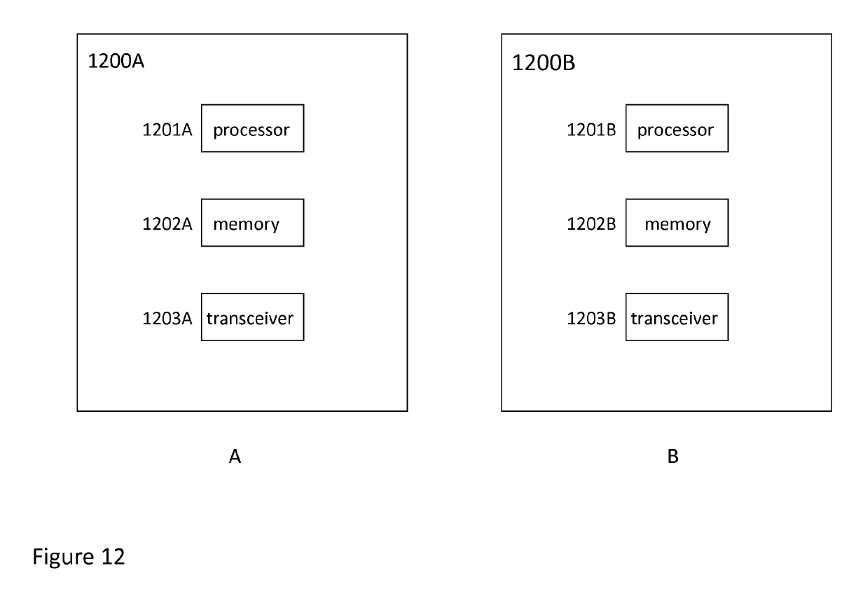

FIG. 12 illustrates two apparatuses according to certain embodiments of the invention. In one embodiment, the apparatus A may be a VNFM 1200A. The apparatus 1200A may comprise at least one processor (or processing means), indicated as 1201A. At least one memory may be provided in the device, and indicated as 1202A. The memory may include computer program instructions or computer code contained therein. The processor 1201A and memory 1202A or a subset thereof, can be configured to provide means corresponding to the various blocks of FIG. 12A. The processor (or processing means) may be embodied by any computational or data processing device, such as a central processing unit (CPU), application specific integrated circuit (ASIC), or comparable device. The processor can be implemented as a single controller, or a plurality of controllers or processors.

As shown in FIG. 12A, a transceiver (or transceiving means) 1203A may be provided. The transceiver 1203A may be a transmitter, a receiver, or both a transmitter and a receiver, or a unit or device that is configured both for transmission and reception.

Memory 1202A may be any suitable storage device, such as a non-transitory computer-readable medium. In one embodiment of the invention, the memory 1202A may be in the form of a database. A hard disk drive (HDD), random access memory (RAM), flash memory, or other suitable memory can be used. The memory may be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor (or processing means) for the particular device, to cause a hardware apparatus such as an apparatus 1200A, to perform any of the processes described herein (for example, FIG. 10). The topology database may be stored in the memory 1202A. In certain embodiments, a non-transitory computer-readable medium can be encoded with computer instructions that, when executed in hardware, perform a process such as one of the processes described herein. Alternatively, certain embodiments of the invention can be performed entirely in hardware. Furthermore, although FIG. 12A illustrates network element such as a VNFM, embodiments of the invention may be applicable to other configurations, and configurations involving additional elements. For example, not shown, additional network element may be present, and additional core/radio network elements may be present.

In another embodiment, an apparatus B as shown in FIG. 12B may be a VM or a server 1200B. The apparatus 1200B may comprise at least one processor (or processing means), indicated as 1201B. At least one memory may be provided in the device, and indicated as 1202B. The memory may include computer program instructions or computer code contained therein. The processor 1201B and memory 1202B or a subset thereof, can be configured to provide means corresponding to the various blocks of FIG. 12B. The processor (or processing means) may be embodied by any computational or data processing device, such as a central processing unit (CPU), application specific integrated circuit (ASIC), or comparable device. The processor can be implemented as a single controller, or a plurality of controllers or processors.

As shown in FIG. 12B, a transceiver (or transceiving means) 1203B may be provided. The transceiver 1203B may be a transmitter, a receiver, or both a transmitter and a receiver, or a unit or device that is configured both for transmission and reception.

Memory 1202B may be any suitable storage device, such as a non-transitory computer-readable medium. In one embodiment of the invention, the memory 1202B may be in the form of a database. A hard disk drive (HDD), random access memory (RAM), flash memory, or other suitable memory can be used. The memory may be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor (or processing means) for the particular device, to cause a hardware apparatus such as an apparatus 1200B, to perform any of the processes described herein (for example, FIG. 11). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware. Furthermore, although FIG. 12B illustrates network element such as a VM or a server, embodiments of the invention may be applicable to other configurations, and configurations involving additional elements. For example, not shown, additional network element may be present, and additional core/radio network elements may be present.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention. In order to determine the metes and bounds of the invention, therefore, reference should be made to the appended claims.

For the purpose of the present invention as described above, it should be noted that
method steps likely to be implemented as software code portions and being run using a processor at one of the server entities are software code independent and can be specified using any known or future developed programming language;
method steps and/or devices likely to be implemented as hardware components at one of the server entities are hardware independent and can be implemented using any known or future developed hardware technology or any hybrids of these, such as MOS, CMOS, BiCMOS, ECL, TTL, etc, using for example ASIC components or DSP components, as an example;
generally, any method step is suitable to be implemented as software or by hardware without changing the idea of the present invention;
devices can be implemented as individual devices, but this does not exclude that they are implemented in a distributed fashion throughout the system, as long as the functionality of the device is preserved.

It is to be understood that the above description is illustrative of the invention and is not to be construed as limiting the invention. Various modifications, applications and/or combination of the embodiments may occur to those skilled in the art without departing from the scope of the invention as defined by the appended claims.

### 3GPP 3rd Generation Partnership Project

### API Application Programming Interface

### DPI Deep Packet Inspection

### EoR End of Row

### ETSI European Telecommunications Standards Institute

### IP Internet Protocol

### NFV Network Function Virtualization

### NFVI Network Function Virtualization Infrastructure

### NS Network Service

### PCC Policy and Charging Control

### QoS Quality of Service

### SR-IOV Single Root Input/Output Virtualization

### ToR Top of Rack

### VIM Virtualised Infrastructure Manager

### VM Virtual Machine

### VNF Virtual Network Function

### VNFM Virtual Network Function Manager

### VNFO Virtual Network Function Orchestrator

1. A method for a first apparatus in a communication network, wherein said communication network comprising the first apparatus, a second apparatus and a plurality of servers, said method comprising:
sending at least a message to the second apparatus to obtain zone information of each of said plurality of servers;
receiving the requested zone information from the second apparatus; and
building a topology database based on the received zone information.

2. The method for the first apparatus according to claim 1, further comprising:
receiving a request from a first server in order to find a preferred peer server, wherein the first server and the preferred peer server are among said plurality of servers and the zone information of the preferred peer server comprises all the zones where the first server is located;
updating the topology database by establishing peer relationship between the first server and its peer servers;
identifying all the preferred peer servers from the peer servers based on the zone information in the topology database; and
sending a list of all the preferred peer servers to the first server.

3. The method for the first apparatus according to claim 2, further comprising:
receiving a notification from the first server, wherein said notification notifying the first apparatus to send an updated list of the preferred peer servers to the first server if any change in the topology database is relevant to the first server;
updating the topology database in case of any change in the topology database; and sending an updated list of the preferred peer servers to the first server if the change in the topology database is relevant to the first server.

4. The method for the first apparatus according to claim 1, further comprising:
setting a periodic timer; and
sending the message to the second apparatus in order to obtain zone information of each of said plurality of servers when the timer expires.

5. The method for the first apparatus according to claim 1, wherein a zone is formed based on anyone or any combination of the following characteristic of the plurality of servers:
physical location,
bandwidth,
QoS guarantees,
HW computing host capabilities,
SW computing host capabilities.

6. A method for a first server among a plurality of servers in a communication network, wherein said communication network comprising a first apparatus and said plurality of servers, said method comprising:
receiving a list of preferred peer servers from the first apparatus, wherein the preferred peer servers are among said plurality of servers and the zone information of any preferred peer server comprises all the zones where the first server is located;
selecting a preferred peer server from the list; and
requesting service from the selected preferred peer server.

7. The method for the first server according to claim 6, further comprising
sending a request to the first apparatus to find a preferred peer server from the plurality of servers.

8. The method for the first server according to claim 6, further comprising
sending a notification to the first apparatus to obtain an updated list of the preferred peer servers if any change in the topology database is relevant to the first server.

9. The method for the first server according to claim 6, wherein a zone is formed based on anyone or any combination of the following characteristics of the plurality of servers:
physical location,
bandwidth,
QoS guarantees,
HW computing host capabilities,
SW computing host capabilities.

10. A first apparatus in a communication network, wherein said communication network comprising the first apparatus, a second apparatus and a plurality of servers, said first apparatus comprising:
a transceiver configured to communicate with at least the second apparatus and anyone of said plurality of servers,
a memory configured to store at least computer program code, and
a processor configured to cause the first apparatus to perform:
sending at least a message to the second apparatus to obtain zone information of each of said plurality of servers;
receiving the requested zone information from the second apparatus;
building a topology database based on the received zone information.

11. The first apparatus according to claim 10, wherein said processor is further configured to cause the first apparatus to perform
receiving a request from a first server in order to find a preferred peer server, wherein the first server and the preferred peer server are among said plurality of servers and the zone information of the preferred peer server comprises all the zones where the first server is located;
updating the topology database by establishing peer relationship between the first server and its peer servers;
identifying all the preferred peer servers from the peer servers based on the zone information in the topology database; and
sending a list of all the preferred peer servers to the first server.

12. The first apparatus according to claim 11, wherein said processor is further configured to cause the first apparatus to perform
receiving a notification from the first server, wherein said notification notifying the first apparatus to send an updated list of the preferred peer servers to the first server if any change in the topology database is relevant to the first server;
updating the topology database in case of any change in the topology database; and sending an updated list of the preferred peer servers to the first server if the change in the topology database is relevant to the first server.

13. The first apparatus according to claim 10, wherein said processor is further configured to cause the first apparatus to perform
setting a periodic timer; and
sending the message to the second apparatus in order to obtain zone information of each of said plurality of servers when the timer expires.

14. The first apparatus according to claim 10, wherein a zone is formed based on anyone or any combination of the following characteristic of the plurality of servers:
physical location,
bandwidth,
QoS guarantees,
HW computing host capabilities,
SW computing host capabilities.

15. A first server among a plurality of servers in a communication network, wherein said communication network comprising a first apparatus and said plurality of servers, said first server comprising:
a transceiver configured to communicate with at least the first apparatus,
a memory configured to store at least computer program code, and
a processor configured to cause the first server to perform:
receiving a list of preferred peer servers from the first apparatus, wherein the preferred peer servers are among said plurality of servers and the zone information of any preferred peer server comprises all the zones where the first server is located;
selecting a preferred peer server from the list; and
requesting service from the selected preferred peer server.

16. The first server according to claim 15, wherein said processor is further configured to cause the first server to perform
sending a request to the first apparatus to find a preferred peer server from the plurality of servers.

17. The first server according to claim 15, wherein said processor is further configured to cause the first server to perform
sending a notification to the first apparatus to obtain an updated list of the preferred peer servers if any change in the topology database is relevant to the first server.

18. The first server according to claim 15, wherein a zone is formed based on anyone or any combination of the following characteristics of the plurality of servers:
physical location,
bandwidth,
QoS guarantees,
HW computing host capabilities,
SW computing host capabilities.

19. A computer program product embodied on a non-transitory computer-readable medium, said product comprising computer-executable computer program code which, when the computer program code is executed on a computer, is configured to cause the computer to carry out the method according to claim 1.

20. (canceled)

21. A computer program product embodied on a non-transitory computer-readable medium, said product comprising computer-executable computer program code which, when the computer program code is executed on a computer, is configured to cause the computer to carry out the method according to claim 6.
